(19) United States
(12) Patent Application Publication
(10) Pub. No.: US 2005/0254865 A1
(43) Pub. Date: Nov. 17, 2005

(54) Fixing apparatus and duplex image-forming apparatus

(76) Inventor: Hidetoshi Katayanagi, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 10/993,415

(22) Filed: Nov. 18, 2004

(30) Foreign Application Priority Data
May 14, 2004 (JP) JP2004-145258

(51) Int. Cl. G03G 15/20

(52) U.S. Cl. 399/324

(57) ABSTRACT

A fixing apparatus for fixing toner including wax for release agent on a transfer material having a first and a second rotatable fixing members, between which the transfer material is conveyed, to fix the toner on the transfer material with heat, an external rotatable member provided in contact with at least one of the first and the second rotatable fixing members and a spreading blade for spreading the wax, provided in contact with at least one of the first rotatable fixing member, the second rotatable fixing member and the external rotatable member.

### BACKGROUND OF THE INVENTION

The present invention relates to a fixing apparatus and a duplex image-forming apparatus.

Generally speaking, in a duplex image-forming apparatus based on the electro-photographic method, there has been widely employed a fixing apparatus, which is provided with a first rotatable fixing member for contacting a surface of a transfer material and a second rotatable fixing member disposed opposite to the first rotatable fixing member so as to press-contact the first rotatable fixing member, in order to fix a toner image formed on one side of the transfer material with heat and pressure onto the transfer material, such as a paper, etc.

In such the fixing apparatus, a non-fixed toner image formed on the transfer material is fixed with heat and pressure onto the transfer material by conveying it through a fixing nip portion, which is formed by press-contacting a pressing roller, serving as the second rotatable fixing member, onto a fixing roller, serving as the first rotatable fixing member, while pressing and heating the transfer material between the fixing roller and the pressing roller. In the mid-course of the abovementioned fixing operation, an offset phenomenon, in which toner particles or the like transferred from the transfer material are attached to the fixing roller, is liable to occur. There have been such the problems that this offset phenomenon causes contaminations of the fixed image and causes the transfer material having a high-density toner image to be wound around the fixing roller. Conventionally, to solve the abovementioned problems, the fixing apparatus having a structure for applying silicon oil onto the fixing rotatable member is set forth in, for instance, Tokkai 2002-258657, Tokkaihei 7-104602 and Tokkaihei 9-166933 (Japanese Non-Examined Patent Publication).

The transfer material fixed by such the conventional fixing apparatus, however, yields a sticky feeling to the user as a result of transferring the silicon oil to the surface of the transfer material, resulting in a low quality of the fixed image.

Accordingly, as a method without employing the silicon oil, toner including a toner resin and a wax material, performing as a release agent, have been also employed for forming image in the conventional image-forming apparatus.

According to the toner including the wax, since the melted wax created by heating it during the fixing operation oozes between the toner resin and the fixing roller, the adhesive force between the toner resin and the fixing roller is weakened, so as to impede an occurrence of transferring the toner to the fixing roller and so as to prevent the transfer material from being wound around the fixing roller.

In the abovementioned method, however, there is a possibility that toner would be positioned at a deviated area, depending on a kind of image to be formed on the transfer material (for instance, an image having toner only at its center area or only at its peripheral area). Accordingly, since the wax is also positioned at a deviated area, there has been a problem that it is impossible to sufficiently acquire the effect of preventing the transfer material from being wound around the fixing roller and the releasing effect of preventing the toner from attaching to the fixing roller. On the other hand, sometimes, a soft material would be employed for covering the fixing rotatable member. In such the case, there has been another problem that, when the leveling member, etc. for spreading the toner over the surface of the fixing rotatable member is directly pushed onto the fixing rotatable member in order to spread the toner positioned at deviated area, the fixing rotatable member is deformed and/or its rotating torque decreases.

On the other hand, in order to forcibly peel off the transfer material from either the fixing roller or the pressing roller, a device in which a forced release means including a plate-type release member is equipped opposite to such the rollers, and, for instance, the distance between the fixing roller and the release member is kept in a range of 0.005-0.1 mm or 0.05-0.3 mm, is set force in, for instance, Tokkaihei 11-184300 and Tokkai 2001-83832 (Japanese Non-Examined Patent Publication).

Incidentally, although it is necessary to keep the distance between the fixing roller and the release member within the abovementioned range, it could not be a realistic solution for this problem when considering a straightness of the release member, a case of a parts changing operation for the pressing roller, etc., since the distance range is too small, compared to dispersion degree of an outer-diameter of a pressing roller to be changed. The release member contacting the fixing roller can be considered as a structure for solving the abovementioned problem. As aforementioned, however, under the condition that the wax is positioned at a deviated area on the fixing roller, there would be also a problem that the release member possibly hurts the fixing roller.

### SUMMARY OF THE INVENTION

To overcome the abovementioned drawbacks in conventional fixing apparatus, it is an object of the present invention to provide fixing apparatus, which make it possible to acquire a good releasability of the transfer material or the toner for the rotatable fixing roller, and to prevent the release member, etc., from hurting the surface of the rotatable fixing roller, by employing toner including a wax, having a releasing performance, and by spreading the wax all over the surface of the rotatable fixing roller.

Further, another object of the present invention is to provide a duplex image-forming apparatus equipped with the fixing apparatus embodied in the present invention.

Accordingly, to overcome the cited shortcomings, the abovementioned object of the present invention can be attained by a fixing apparatus described as follow.

A fixing apparatus for fixing toner including wax for release agent on a transfer material, comprising: a first and a second rotatable fixing members, between which the transfer material is conveyed, to fix the toner on the transfer material with heat; an external rotatable member provided in contact with at least one of the first and the second rotatable fixing members; and a spreading blade for spreading the wax, provided in contact with at least one of the first rotatable fixing member, the second rotatable fixing member and the external rotatable member.

### BRIEF DESCRIPTION OF THE DRAWINGS

Other objects and advantages of the present invention will become apparent upon reading the following detailed description and upon-reference to-the drawings in which:

FIG. 1 shows an explanatory schematic diagram of an exemplified configuration of a duplex image-forming apparatus, embodied in the present invention;

FIG. 2 shows an explanatory schematic diagram of an exemplified configuration of a fixing apparatus equipped in a duplex image-forming apparatus, embodied in the present invention;

FIG. 3 shows an explanatory schematic diagram of another exemplified configuration of a fixing apparatus equipped in a duplex image-forming apparatus, embodied in the present invention; and

FIG. 4 shows an explanatory schematic diagram of still another exemplified configuration of a fixing apparatus equipped in a duplex image-forming apparatus, embodied in the present invention.

### DETAILED DESCRIPTION OF THE PREFERRED EMBODIMENT

### First Embodiment

The first embodiment of the present invention will be detailed in the following.

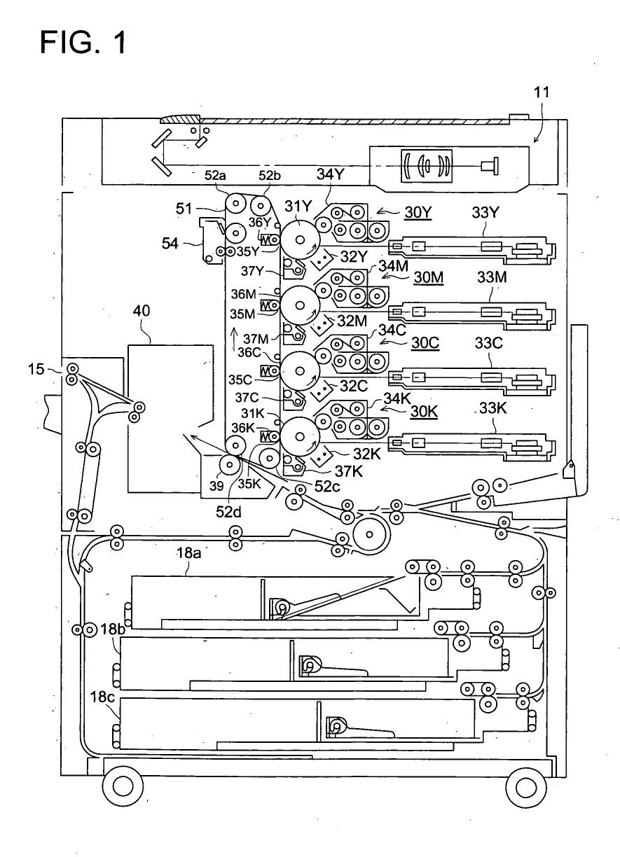

FIG. 1 shows an explanatory schematic diagram of an exemplified configuration of a duplex image-forming apparatus as a best mode of the present invention.

The duplex image-forming apparatus shown in FIG. 1 is a color duplex image-forming apparatus, which is provided with: image-reading section 11 for generating image data by optically scanning a document image to be read; photoreceptor drums 31Y, 31M, 31C, 31K on each surface of which a single-color toner image is formed on the basis of the image data sent from image-recording section 11; developing devices 30Y, 30M, 30C, 30K for forming the single-color toner images on photoreceptor drums 31Y, 31M, 31C, 31K; intermediate transfer belt 51 for bearing a full-color toner image formed by primarily transferring the single-color toner images, formed by developing devices 30Y, 30M, 30C, 30K, by means of press-contacting rollers 36Y, 36M, 36C, 36K, which are press-contacts photoreceptor drums 31Y, 31M, 31C, 31K; secondary transfer section 39 for transferring the full-color toner image, serving as a primary-transferred toner image formed on the surface of intermediate transfer belt 51, onto a surface of transfer material P such as a paper, etc.; fixing apparatus 40 for fixing the full-color toner image, serving as a secondary-transferred toner image transferred onto the surface of transfer material P, with heat and pressure onto transfer material P; conveying mechanisms for conveying transfer material P; and ejecting outlet 15 for ejecting transfer material P for which a formation of a visible image is already completed.

Further, as shown in FIG. 1, the color duplex image-forming apparatus also provided with photoreceptor-drum cleaning sections 37Y, 37M, 37C, 37K, intermediate-transfer belt cleaning section 54 and transfer-material accommodating sections 18a, 18b, 18c.

The photoreceptor drums 31Y, 31M, 31C, 31K are disposed in parallel in a circulating direction of intermediate transfer belt 51, along the straight-downward portion of intermediate transfer belt 51, serving as an endless belt which is movably threaded on, for instance, a plurality of supporting rollers 52a, 52b, 52c, 52d so as to circularly moves in a direction indicated by the arrow shown in FIG. 1. Further, each of developing devices 30Y, 30M, 30C, 30K is disposed at such a position corresponding to each of photoreceptor drums 31Y, 31M, 31C, 31K.

Incidentally, developing device 30Y forms a yellow toner image, developing device 30M forms a magenta toner image, developing device 30C forms a cyan toner image and developing device 30K forms a black toner image. Further, when forming duplex image on the transfer material, the abovementioned image-forming operation is performed for each of obverse and reverse surfaces of the transfer material.

The developing devices 30Y is provided with: charging device 32Y for uniformly charging photoreceptor drum 31Y by employing corona discharge generated between, for instance, a grid and a corona discharging wire; image exposing section 33Y for forming an electrostatic latent image on the surface of photoreceptor drums 31Y by irradiating laser beam emitted from, for instance, a laser diode onto photoreceptor drum 31Y uniformly charged by charging device 32Y to conduct an exposing operation based on the image data outputted from image-reading section 11; and developing device 34Y for developing the electrostatic latent image formed on the surface of photoreceptor drum 31Y. The charging device 32Y, image exposing section 33Y and developing device 34Y are disposed at the outer peripheral area of photoreceptor drum 31Y, which rotates so as to move in a forward direction (indicated by the arrow shown in FIG. 1) at the transferring position to intermediate transfer belt 51, along the rotating direction thereof.

Further, with respect to the other developing devices 30M, 30C, 30K, each of them has the same structure as that of developing device 30Y.

According to such the duplex image-forming apparatus as mentioned in the above, by activating all of four developing devices 30Y, 30M, 30C, 30K, it is possible to form a full color image, so to speak. On the other hand, by selectively activating one of four developing devices 30Y, 30M, 30C, 30K, it is possible to form a single color image, for instance, a monochrome image when selectively activating only developing device 30K.

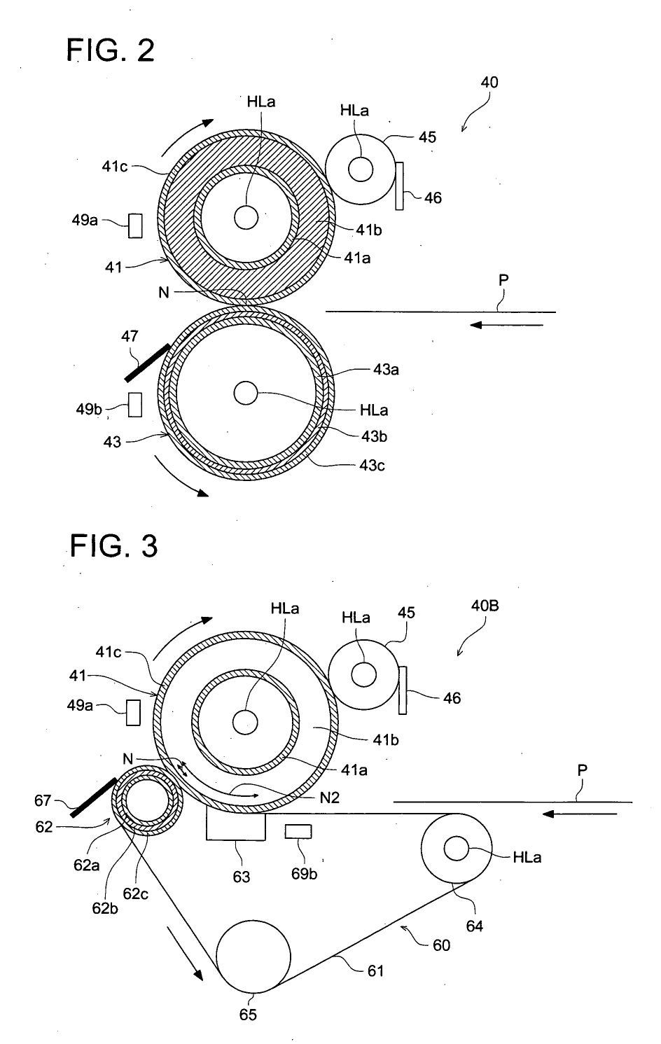

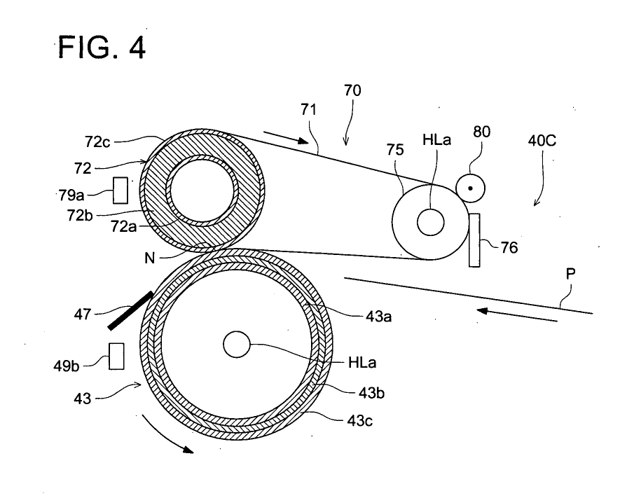

As shown in FIG. 2, the fixing apparatus 40 is provided with: fixing roller 41, serving as a first rotatable fixing member, disposed at such a position that one side of transfer material P (for instance, upper side of transfer material P shown in FIG. 2), on which a non-fixed toner image is already formed, contacts the outer surface of fixing roller 41; and pressing roller 43, serving as a second rotatable fixing member, disposed at such a position that pressing roller 43 press-contacts fixing roller 41. The fixing apparatus 40 is further provided with: external heating roller 45, serving as an extern rotatable rotating member, disposed at such a position that external heating roller 45 contacts the outer surface of fixing roller 41; and wax spreading blade 46, serving as a spreading blade, disposed at such a position that wax spreading blade 46 presses external heating roller 45. In the present embodiment, in order to improve the releasing performance, fixing apparatus 40 includes forced release means 47 disposed at such a position that an leading edge portion of forced release means 47 contacts pressing roller 43. A fixing nip section N, having a crown-shape in which pressing roller 43 is convex relative to fixing roller 41, is formed at the press-contacting section of fixing roller 41 and pressing roller 43. Further, numerals 49a and 49b shown in FIG. 2 denote noncontact temperature-detecting means.

As shown in FIG. 2, fixing roller 41 is a soft roller, which internally incorporates heating source Hla including a heater lamp, for instance, such as a halogen lamp, etc., and comprises: cylindrical core metal 41a in which heating source Hla is disposed; heat-resistant elastic layer 41b formed on the outer surface of cylindrical core metal 41a; and coating layer 41c formed on the outer surface of heat-resistant elastic layer 41b through a adhesive layer (not shown in the drawings) including an agent made by baking a coated latex, for instance, being a mixture of fluororubber and fluororesin.

The heating source Hla is disposed in cylindrical core metal 41a in such a manner that heating source Hla extends in a longitudinal direction of fixing roller 41. Further, heating source Hla is controlled in, for instance, an ON/OFF switching mode by a controlling means (not shown in the drawings), based on the surface temperatures detected by noncontact temperature-detecting means 49a, so that the temperature at outer surface of fixing roller 41, being a direct heating object, can be maintained within a established temperature range.

Incidentally, although heating source Hla is disposed inside fixing roller 41 in the abovementioned example, the scope of the present invention is not limited to the above. It is also applicable that heating source Hla is disposed outside fixing roller 41 in such a manner that heating source Hla is either contacting or non-contacting fixing roller 41.

Although, for instance, a silicon rubber, an expanded silicon rubber, a fluororubber, etc. can be cited as a heat-resistant material to be employed for heat-resistant elastic layer 41b, it is especially desirable to employ a silicon rubber. Further, it is also desirable that the thickness of heat-resistant elastic layer 41b is in a range of 1.0-4.0 mm.

When the thickness of heat-resistant elastic layer 41b is equal to or smaller than 0.2 mm, there is a fear that a high-quality visible image could not be formed, since the surface of fixing roller 41 hardly follows the unevenness of the surface of transfer material P, which bears a toner image to be fixed with heat. Further, when the thickness of heat-resistant elastic layer 41b is smaller than 1.0 mm, it becomes difficult to secure a sufficient width of fixing nip section N, since the shape of fixing roller 41 becomes convex relative to pressing roller 43.

On the other hand, when the thickness of heat-resistant elastic layer 41b is excessively large, there is a fear that a thermal conducting response, from heating source Hla disposed inside cylindrical core metal 41a to the surface of fixing roller 41, could not be sufficiently secured.

Although a material employed for cylindrical core metal 41a is not limited to a specific one, an aluminum, an iron, a cupper, etc., or an alloy of such the metals can be cited as a usable material thereof.

The coating layer 41c has a function as a toner-releasing layer for preventing the toner from attaching thereto. Accordingly, it is desirable that coating layer 41c is made of a releasable resin including a fluororesin selected from a polytetrafluoroethylene (PTFE), a copolymer (PFA) of tetrafluoroethylene and perfluoroalkoxyethylene and a copolymer (FEP) of tetrafluoroethylene and hexafluoropropylene, and the thickness of coating layer 41c is equal to or smaller than 50 μm.

By employing the fluororesin for coating layer 41c, it becomes possible to improve the releasability of fixing roller 41 for the toner due to the releasing performance of the coating layer 41c. Accordingly, adhesion materials originally caused by the toner hardly attached to the surface of fixing roller 41 without applying the releasing oil, such as silicon oil, etc., onto fixing roller 41, and it also becomes possible to improve the other releasability of fixing roller 41 for transfer material P.

By setting the thickness of coating layer 41c at such a value as equal to or smaller than 50 μm, the surface of fixing roller 41 can easily follow the unevenness residing on the surface of transfer material P on which the non-fixed toner image is already formed, resulting in a suppression of the deterioration of the image quality.

Incidentally, in order to make it easy to form coating layer 41c as a uniform layer, it is still desirable that the thickness of coating layer 41c is set at such a value as equal to or smaller than 20 μm.

Concretely speaking, for instance, coating layer 41c, having a thickness in a range of 20-50 μm, can be formed (1) by applying the releasable resin in a dispersion state and baking the layer applied, or (2) by coating and adhering a releasable resin tube, having a thickness in a range of 20-50 μm, over the fixing roller 41, or by etc.

A hardness of fixing roller 41 is set at a value in a range of 60-85° measured with a load of 9.8 N as an Asker-C hardness criterion by using the Asker-C-type measuring instrument manufactured by KOUBUNSHI KEIKI CO. LTD.

As shown in FIG. 2, a soft roller, which comprises: for instance, cylindrical core metal 43a; heat-resistant elastic layer 43b formed on the outer surface of cylindrical core metal 43a; and coating layer 43c formed on the outer surface of heat-resistant elastic layer 43b, can be employed as pressing roller 43.

In the example shown in FIG. 2, pressing roller 43 internally incorporates heating source Hla as well as fixing roller 41. The heating source Hla is disposed in cylindrical core metal 43a in such a manner that heating source Hla extends in a longitudinal direction of pressing roller 43. Further, heating source Hla is controlled in, for instance, an ON/OFF switching mode by a controlling means (not shown in the drawings), based on the surface temperatures detected by noncontact temperature-detecting means 49b, so that the temperature at outer surface of pressing roller 43, being a direct heating object, can be maintained within a established temperature range.

Incidentally, although heating source Hla is disposed inside pressing roller 43 in the abovementioned example, the scope-of the present invention is not limited to the above. It is also applicable that heating source Hla is disposed outside pressing roller 43 in such a manner that heating source Hla is either contacting or non-contacting pressing roller 43.

Although, for instance, a silicon rubber, an expanded silicon rubber, a fluororubber, etc. can be cited as a heat-resistant material to be employed for heat-resistant elastic layer 43b, it is especially desirable to employ a silicon rubber. If the hardness of heat-resistant elastic layer 43b is substantially the same as that of heat-resistant elastic layer 41b, the thickness of heat-resistant elastic layer 43b is set at a value thinner than that of heat-resistant elastic layer 41b, and usually, is set at a value in a range of 0.5-3 mm. By setting the thickness of heat-resistant elastic layer 43b at a value thinner than that of heat-resistant elastic layer 41b, it becomes possible to yield the crown shape at the nip portion, in which the shape of pressing roller 43, serving as a second fixing roller, is convex relative to fixing roller 41, serving as a first fixing roller.

Although a material employed for cylindrical core metal 43a is not limited to a specific one, an aluminum, an iron, a cupper, etc., or an alloy of such the metals can be cited as a usable material thereof.

For instance, a resin, mainly including a fluororesin selected from a polytetrafluoroethylene (PTFE), a copolymer (PFE) of tetrafluoroethylene and perfluoroalkoxyethylene, a copolymer (FEP) of tetrafluoroethylene and hexafluoropropylene, etc., can be cited as a concrete example of a material to be employed for coating layer 43c.

Concretely speaking, for instance, coating layer 43c, having a thickness in a range of 20-50 μm, can be formed (1) by applying the releasable resin in a dispersion state and baking the layer applied, or (2) by coating and adhering a releasable resin tube, having a thickness in a range of 20-50 μm, over the fixing roller 41, or by etc.

It is desirable that a hardness of pressing roller 43 is equal to or greater than that of fixing roller 41, and, for instance, is set at a value in a range of 65-90° as the Asker-C hardness criterion.

A roller, which comprises a cylindrical core metal internally including heating source Hla, such as a halogen lamp, etc., and a coating layer formed on the outer surface of the cylindrical core metal, can be employed as external heating roller 45.

The wax spreading blade 46 is shaped in a plate by molding an elastic material, such as a silicon rubber, a fluororubber, etc. The thickness of wax spreading blade 46 is set at, for instance, 3 mm. Further, wax spreading blade 46 is disposed at such a position that it press-contacts the surface of external heating roller 45 so that it extends in a same direction as the rotating direction of external heating roller 45. Still further, its pressing force is set at a value in a range of, for instance, 100-500 mN/cm. It is also applicable that a fluororesin is coated on the surface of wax spreading blade 46.

The forced release means 47 is a plate-shaped member, which has a releasing layer formed by, for instance, laminating a thin film made of a fluororesin, such as a polytetrafluoroethylene (PTFE), etc., onto a thin stainless-steel plate having a thickness of 0.2 mm.

In the duplex image-forming apparatus having the structure described in the foregoing, either a two component developer including both toner and carrier or a one component developer including only toner.

For instance, a toner resin including an integrity resin and a coloring agent or another toner including a wax agent having a releasing performance is usually employed as the abovementioned toner. It is specifically desirable to employ a toner mingled with inorganic fine particles as additives.

Although a kind of the integrity resin is not limited to a specific one, a well-known resin, such as a styrene resin, an acrylic resin, a copolymer of styrene and acrylic, a polyester resin can be employed as the integrity resin.

As the coloring agent, for instance, a carbon black dye, a nigrosine dye, etc., are employed for the black toner, while C.I. pigment blue 15:3, C.I. pigment blue 15, C.I. pigment blue 15:6, C.I. pigment blue 68, C.I. pigment red 48-3, C.I. pigment red 122, C.I. pigment red 212, C.I. pigment red 57-1, C.I. pigment yellow 17, C.I. pigment yellow 81, C.I. pigment yellow 154, etc. can be desirably employed for the pigments necessary for yellow toner, magenta toner and cyan toner.

It is possible to add a charge controlling agent, a fluidizing agent, a smoother, a cleaning assistant agent and other kinds of additives to toner particles as needed, and it is also possible to employ well-known materials as such the additives.

A polymerization method for acquiring toner, such as an emulsion polymerization method, a suspension polymerization method, etc., can be utilized as a manufacturing method of the toner. According to such the manufacturing method, it is possible to easily acquire such toner that has a specific shape factor and a high spherical degree, and the distribution of physical properties, such as the distribution of toner diameters, the distribution of charge amounts, etc., exhibit sharp changes, or has a small diameter for each of toner particles. Among other things, it is desirable to employ the manufacturing method, set forth in Tokugan 2003-146007, etc., in which the suspension polymerization method is utilized.

Further, in the abovementioned method, it is possible to mingle the inorganic fine particles with the toner as external additives.

A toner made by fusing resin particles, which internally includes a wax having the releasing performance, in a water-type agent, (hereinafter, also referred to as a “wax-included toner”) can be desirably employed. Concretely speaking, the wax-included toner can be manufactured by the method for acquiring the toner in which the wax is finely dispersed, for instance, the method including the steps of: acquiring the resin particles, which internally includes the wax having the releasing performance, by employing a mini-emulsion polymerization method; and salting out and fusing the resin particles and the coloring particles in the water-type agent.

A low-molecular weight polypropylen, a low-molecular weight polyethylene, having a numerical average molecular weight is in a range of 1500-9000, etc. are preferably employed as the wax having the releasing performance. Further, specifically, the crystalline compound, having the ester group expressed by general formula (1) shown in the following, is more preferably employed.
R1-(OCO-R2)n Formula (1)

In general formula (1), R1 and R2 indicate carbon hydrides, each of which may independently have a substituent group, and “n” is an integer in a range of 1-4, preferably in a range of 2-4, more preferably in a range of 3-4, still more preferably equal to 4. Further, R1 has a carbon atom number in a range of 1-40, preferably in a range of 1-20, more preferably in a range of 2-5, while R2 has a carbon atom number in a range of 1-40, preferably in a range of 16-30, more preferably in a range of 18-26.

Concretely speaking, a natural wax, such as a higher fatty acid ester, a carbana wax, a rice wax, etc., and a crystalline polypropylen can be cited as the wax having the releasing performance.

It is desirable that the inclusion ratio of the wax having the releasing performance in the toner particles is in a range of 1-30%-by-mass, more preferably in a range of 7-23%-by-mass.

By setting the inclusion ratio of the wax having the releasing performance at a value equal to or greater than 7%-by-mass, an appropriate amount of the melted wax oozes at the fixing nip portion N from the toner forming the toner image during the fixing operation. Such the melted wax allows fixing apparatus 40 to suppress occurrences of an offset phenomenon and a winding up defect of the transfer material P more effectively than ever.

On the other hand, by setting the inclusion ratio of the wax having the releasing performance at a value equal to or smaller than 23%-by-mass, it becomes possible to prevent the excessive amount of the wax from adhering to the surface of fixing roller 41 more effectively than ever.

It is preferable that the melting point of the wax having the releasing performance is in a range of 60-110°, more preferably in a range of 70-90°.

According to the toner including the wax having the releasing performance and the melting point in the range mentioned in the above, since an appropriate amount of the melted wax oozes at the fixing nip portion N from the toner forming the toner image during the fixing operation, it becomes possible to suppress occurrences of an offset phenomenon and a winding up defect of the transfer material P more effectively than ever.

Incidentally, the “melting point of the wax having the releasing performance” is defined as a value measured by the Differential Scanning Calorimetry (DSC). Concretely speaking, when heating the wax under the condition of 10° C./min from 0° C. to 200° C. (the first heat-up process), a temperature at which a maximum peak value of heat absorption is exhibited in the measurement, is determined as the melting point.

The operations of the duplex image-forming apparatus described in the forgoing will be detailed in the following.

When all of developing devices 30Y, 30M, 30C, 30K are activated to form the full color image, image-reading section 11 reads the original image to acquire image data. By conducting the exposing operation by means of image exposing sections 33Y, 33M, 33C, 33K respectively equipped in developing devices 30Y, 30M, 30C, 30K, based on the image data acquired, electrostatic latent images are respectively formed on the surfaces of photoreceptor drums 31Y, 31M, 31C, 31K. Successively, toner images having colors being different from each other are acquired by developing the electrostatic latent images with color toners by means of developing devices 34Y, 34M, 34C, 34K. Then, at first transferring sections 35Y, 35M, 35C, 35K, the toner images formed on the surfaces of photoreceptor drums 31Y, 31M, 31C, 31K are sequentially transferred onto the surface of intermediate transfer belt 51 moving in the circulating direction, so that a primary-transferred toner image is formed on intermediate transfer belt 51 by overlapping the toner images with each other.

Incidentally, the residual toner remained on photoreceptor drums 31Y, 31M, 31C, 31K after the first transferring operation is completed, are cleaned up by cleaning sections 37Y, 37M, 37C, 37K when passing through them.

On the other hand, the conveying mechanism takes off transfer material P from, for instance, transfer-material accommodating section 18a, and conveys the transfer material P to secondary transfer section 39 in a state of synchronizing with the movement of intermediate transfer belt 51.

Accordingly, the primary-transferred toner image formed on intermediate transfer belt 51 is further transferred onto the transfer material P conveyed to secondary transfer section 39. Then, the transfer material P, having the secondary-transferred toner image on it, is further conveyed to fixing apparatus 40, in which the secondary-transferred toner image is fixed with heat and pressure onto the transfer material P so as to reproduce a visual image corresponding to the original image on the transfer material P. Successively, the conveying mechanism further conveys the transfer material P, on which the reproduced visual image resides, to ejecting outlet 15 so as to eject the transfer material P outside the duplex image-forming apparatus, resulting in a completion of the full-color image forming operation.

Further, the residual toner, remained on intermediate transfer belt 51 after the transfer material P is separated from it, are cleaned up by intermediate-transfer belt cleaning section 54 when passing through it.

On the other hand, when any one of developing devices 30Y, 30M, 30C, 30K (for instance, only developing device 30K) is activated to form the monochrome image, the toner image is formed only on the surface of photoreceptor drums 31K by means of developing device 30K, based on the image data acquired by reading the original image by means of image-reading section 11, and the primary transferring operation is conducted only by first transferring section 35K. Other than the abovementioned processes, the same image-forming processes as those when forming the full-color image are conducted to form the monochrome image.

During the visual image forming operation conducted in the duplex image-forming apparatus as mentioned in the above, at fixing apparatus 40, transfer material P is conveyed while being pressed by fixing roller 41 an pressing roller 43 between them, and is heated at fixing nip portion N by giving the heat of fixing roller 41 and pressing roller 43, which are heated by heating source Hla, to the transfer material P, so as to perform the fixing operation for fixing the toner image residing on the transfer material P with heat and paressure.

Then, since fixing nip portion N has a specific shape in which pressing roller 43, serving as a second rotatable fixing member, is convex relative to fixing roller 41, serving as a first rotatable fixing member, the transfer material P is conveyed out in a specific direction of approaching pressing roller 43. However, since forced release means 47 is disposed in such a manner that forced release means 47 contacts the surface of pressing roller 43, the transfer material P is surely peeled off pressing roller 43 and is conveyed to the outside of the apparatus from ejecting outlet 15. When forming the fixed images on both sides of transfer material P, after the fixing operation for fixing the toner image formed on the obverse side of the transfer material P is completed, an appropriate reverse-conveying means is employed for reversing the transfer material P, and then, the toner image forming operation, the transferring operation and fixing operation are conducted for the reverse side of the transfer material P as well as those for the obverse side, and finally, the transfer material P having the fixed images on its both sides is conveyed to the outside of the apparatus from ejecting outlet 15.

According to the duplex image-forming apparatus mentioned in the above, since such the shape in which pressing roller 43, serving as a rotatable heating member, is convex relative to fixing roller 41, serving as another rotatable heating member, is formed at fixing nip portion N, the transfer material P is conveyed out in a specific direction in which the transfer material tends to approach pressing roller 43. However, since forced release means 47 is disposed in such a manner that forced release means 47 contacts the surface of pressing roller 43, the transfer material P is surely peeled off pressing roller 43. In addition, since the toner, for forming the toner image, includes the wax, which serves as a lubricant between pressing roller 43 and forced release means 47, it becomes possible to prevent the surface of pressing roller 43 from being hurt by forced release means 47, and as a result, the surface of pressing roller 43 can be always maintained as a flat surface.

In such a case that most of the toner images formed on transfer material P reside at specific positions within a very limited area of the transfer material P in its conveying direction and vertical direction, sometimes, the melted wax oozed from the toner and to be transferred to the fixing roller, the pressing roller, etc. cannot be sufficiently spread all over the area contacting the transfer material P. In the present embodiment, however, since wax spreading blade 46 is disposed in such a manner that wax spreading blade 46 contacts the surface of external heating roller 45, the melted wax oozed from the toner at fixing nip portion N is uniformly leveled by wax spreading blade 46, so that the wax is uniformly spread all over the surface of pressing roller 43 through the surface of fixing roller 41, as a final state. Accordingly, it becomes possible to prevent the surface of pressing roller 43 from being hurt by forced release means 47.

Further, since the releasing layer is formed on forced release means 47, toner, etc. emitted from transfer material P cannot be attached to pressing roller 43.

As described in the foregoing, according to the duplex image-forming apparatus embodied in the present invention, since the duplex image-forming apparatus is provided with such the fixing apparatus as mentioned in the above, it becomes possible to produce the high-quality fixed images over a long period.

Although the concrete embodiment of the present invention has been detailed in the foregoing, the scope of the present invention is not limited to the above example. It is possible for a skilled person to vary the disclosed embodiment without departing from the spirit and scope of the present invention.

For instance, it is not limited that wax spreading blade 46 is disposed at the position so as to contact the surface of the external contacting roller such as external heating roller 45, but it is applicable that wax spreading blade 46 is disposed at a position so as to contact the surface of either fixing roller 41 or pressing roller 43, provided that even the purpose of the wax spreading blade 46 can be achieved. However, when the thickness of the heat-resistant elastic layer of either fixing roller 41 or pressing roller 43 to be contacted by wax spreading blade 46 is equal to or greater than 0.5 mm, the contacting action of the blade causes an increase of the rotating torque of either fixing roller 41 or pressing roller 43. Therefore, it is desirable that wax spreading blade 46 is disposed at the position so as to contact the surface of external heating roller 45.

Further, for instance, if even such the shape in which pressing roller 43, serving as a second rotatable fixing member, is convex relative to fixing roller 41, serving as first rotatable fixing member, can be formed at fixing nip portion N, there is no limitation for making the thickness of heat-resistant elastic layer 41b of fixing roller 41 and that of heat-resistant elastic layer 43b of pressing roller 43 different relative to each other.

Still further, even if external heating roller 45 has no heating source in its inside, external heating roller 45, the surface temperature of which can be raised up to the melting point of the wax while rotating in a state of contacting either fixing roller 41 or pressing roller 43, is applicable within the scope of the present invention.

In the present embodiment described in the foregoing, an example of the color duplex image-forming apparatus employing the fixing apparatus has been detailed. The scope of the fixing apparatus, embodied in the present invention, is not limited to the color duplex image-forming apparatus, but applicable to, for instance, the monochrome duplex image-forming apparatus, etc.

### Second Embodiment

The duplex image-forming apparatus of the second embodiment is provided with the fixing apparatus configured as follows.

As shown in FIG. 3, fixing apparatus 40B includes: fixing roller 41, serving as a first rotatable fixing member, that contacts a surface of transfer material P on which a toner image is formed; external heating roller 45; and wax spreading blade 46. The fixing apparatus 40B further includes: nip-forming roller 62, detailed later; rotatable heating roller 64; supporting roller 65; endless fixing belt 61 threaded on nip-forming roller 62, rotatable heating roller 64 and supporting roller 65; and pushing pad 63. Further, endless fixing belt 61 and pushing pad 63 constitute rotatable pressing member 60, serving as a second rotatable fixing member. Still further, fixing apparatus 40B also includes forced release means 67, which is disposed at such a position that its leading edge contacts rotatable pressing member 60. The fixing nip portion N, having a crown shape in which rotatable pressing member 60, serving as a rotatable heating member, is convex relative to fixing roller 41, is formed at a press-contacting portion of fixing roller 41 and nip-forming roller 62 of rotatable pressing member 60.

The fixing roller 41, external heating roller 45, wax spreading blade 46 and noncontact temperature-detecting means 49a equipped in the second embodiment are the same as those employed in the first embodiment. Further, in fixing apparatus 40B of the second embodiment, temperature-detecting means 69b for detecting temperature of rotatable pressing member 60 is disposed at a position adjacent to the surface of rotatable pressing member 60 or in a state of contacting the surface. The temperature-detecting means 69b is substantially the same as noncontact temperature-detecting means 49b employed in the first embodiment. Still further, a shape and material similar to those of forced release means 47 employed in the first embodiment can be directly applied for forced release means 67.

The rotatable pressing member 60 is constituted by: nip-forming roller 62 that presses fixing roller 41; rotatable heating-roller 64 that incorporates heating source Hla in its inside; supporting roller 65; endless fixing belt 61 that is threaded on nip-forming roller 62, rotatable heating roller 64 and supporting roller 65; and pushing pad 63 that contacts fixing roller 41 through endless fixing belt 61.

The rotatable heating roller 64 has substantially the same structure as that of external heating roller 45 employed in the first embodiment.

The nip-forming roller 62 comprises core metal 62a and heat-resistant elastic layer 62b, so as to press fixing roller 41 with a pressure in a range of, for instance, 0.5-2 mN/cm through endless fixing belt 61 disposed between them.

Although the scope of the metal to be employed for core metal 62a is not limited specifically, a metal, such as, for instance, an iron, an aluminum, a copper, etc., or an alloy of them can be cited as such the metal.

Although, for instance, a silicon rubber, a fluororubber, etc. can be cited as a heat-resistant material to be employed for heat-resistant elastic layer 62b, it is especially desirable to employ a silicon rubber. Further, if the hardness of heat-resistant elastic layer 62b is substantially the same as that of heat-resistant elastic layer 41b, the thickness of heat-resistant elastic layer 62b is set at a value thinner than that of heat-resistant elastic layer 41b, and for instance, is set at a value in a range of 0.1-3 mm.

In the fixing apparatus of this example, it is possible to provide coating layer 62c on the outer surface of heat-resistant elastic layer 62b, which is made of, for instance, a fluororesin.

It is desirable that a hardness of nip-forming roller 62 is equal to or greater than that of fixing roller 41, and, for instance, is set at a value more than 65° as the Asker-C hardness criterion.

The endless fixing belt 61, in which the elastic layer is formed on an endless-belt type substrate and the coating layer is formed on the elastic layer, can be preferably employed in the fixing apparatus, embodied in the present invention.

A metallic material, such as a nickel, stainless steel, etc., or a resin material, such as a polyimide, etc., can be preferably employed as a material of the belt substrate. Further, the thickness of the belt substrate is set at a value in a range of, for instance, 40-60 μm when the metallic material is employed, or is set at a value in a range of, for instance, 50-90 μm when the resin material is employed.

For instance, a silicon rubber, etc. can be employed as a material of the elastic layer. In addition, the thickness of the elastic layer is in a range of, for instance, 150-250 μm.

Further, a fluororesin selected from a polytetrafluoroethylene (PTFE), a copolymer (PFA) of tetrafluoroethylene and perfluoroalkoxyethylene and a copolymer (FEP) of tetrafluoroethylene and hexafluoropropylene, can be employed as a material of the coating layer. In addition, the thickness of the coating layer is in a range of, for instance, 20-50 μm.

The forced release means 67 is disposed at such a position that nip-forming roller 62 is located inside, so as to contact endless fixing belt 61.

The supporting roller 65 is made of a metallic material. Although the scope of the metal to be employed for supporting roller 65 is not limited specifically, a metal, such as, for instance, an iron, an aluminum, a copper, etc., or an alloy of them can be cited as such the metal. From a viewpoint of the stability of belt running performance, a fluororesin, etc. could be preferably coated onto the outer surface of supporting roller 65.

The pushing pad 63 is made by molding such a material as a silicon rubber, etc., and contacts fixing roller 41 with endless fixing belt 61 between them, so that endless fixing belt 61 contacts fixing roller 41 along its surface.

The nip-forming roller 62 presses fixing roller 41 through endless fixing belt 61 while pushing pad 63 contacts fixing roller 41 with endless fixing belt 61 between them, so as to form fixing nip portion N2 between endless fixing belt 61 and fixing roller 41. Further, since the thickness of heat-resistant elastic layer 41b formed on fixing roller 41 is greater than that of heat-resistant elastic layer 62b formed on nip-forming roller 62, such a shape that rotatable pressing member 60, serving as a second rotatable fixing member, is convex relative to fixing roller 41, serving as a first rotatable fixing member, is created at fixing nip portion N by nip-forming roller 62 pressing both fixing roller 41 and endless fixing belt 61.

According to the duplex image-forming apparatus having the fixing apparatus described in the above, it becomes possible to attain the same performance and effects as those attained by the first embodiment.

### Third Embodiment

The duplex image-forming apparatus of the second embodiment is provided with the fixing apparatus configured as follows.

As shown in FIG. 3, fixing apparatus 40C includes: nip-forming roller 72 (detailed later), serving as a first rotatable fixing member, that contacts a surface of transfer material P on which a toner image is formed; external heating roller 75; and endless fixing belt 71 threaded on nip-forming roller 72 and external heating roller 75. Further, endless fixing belt 71, nip-forming roller 72 and external heating roller 75 constitute rotatable fixing member 70. The fixing apparatus 40C further includes: cleaning roller 80, serving as an external rotating member; wax spreading blade 76; pressing roller 43, serving as a second rotatable fixing member; and forced release means 47, which is disposed at such a position that its leading edge contacts pressing roller 43. The press-contacting action of nip-forming roller 72 of rotatable fixing member 70 creates fixing nip portion N, which has such a shape that pressing roller 43 is convex relative to rotatable fixing member 70.

The pressing roller 43, forced release means 47 and temperature-detecting means 49b equipped in the third embodiment are the same as those employed in the first embodiment. Further, external heating roller 75 is substantially the same as external heating roller 45. Still further, in fixing apparatus 40C of the second embodiment, temperature-detecting means 79a for detecting temperature of rotatable fixing member 70 is disposed at a position adjacent to the surface of rotatable fixing member 70 or in a state of contacting the surface of rotatable fixing member 70. The temperature-detecting means 79a is substantially the same as noncontact temperature-detecting means 49b employed in the first embodiment.

Further, nip-forming roller 72, external heating roller 75 and endless fixing belt 71 threaded on the nip-forming roller 72 and the external heating roller 75 constitute rotatable fixing member 70.

The nip-forming roller 72 comprises core metal 72a made of, for instance, a metallic material and heat-resistant elastic layer 72b formed on the outer surface of core metal 72a.

Although the scope of the metal to be employed for core metal 72a is not limited specifically, a metal, such as, for instance, an iron, an aluminum, a copper, etc., or an alloy of them can be cited as such the metal.

Although, for instance, a silicon rubber, an expanded silicon rubber, a fluororubber, etc. can be cited as a heat-resistant material-to be employed for heat-resistant elastic layer 72b, it is especially desirable to employ an expanded silicon rubber. The thickness of heat-resistant elastic layer 72b is larger than that of heat-resistant elastic layer 43b of pressing roller 43, and for instance, is set at a value in a range of 3-8 mm.

In the fixing apparatus of this example, it is possible to provide coating layer 72c on the outer surface of heat-resistant elastic layer 72b, which is made of, for instance, a fluororesin.

It is desirable that a hardness of nip-forming roller 72 is equal to or smaller than that of pressing roller 43, and, for instance, is set at a value in a range of 35-80° as the Asker-C hardness criterion.

The endless fixing belt 71, in which the elastic layer is formed on an endless-belt type substrate and the coating layer is formed on the elastic layer, can be preferably employed in the fixing apparatus, embodied in the present invention.

A metallic material, such as a nickel, stainless steel, etc., or a resin material, such as a polyimide, etc., can be preferably employed as a material of the belt substrate. Further, the thickness of the belt substrate is set at a value in a range of, for instance, 40-60 μm when the metallic material is employed, or is set at a value in a range of, for instance, 50-90 μm when the resin material is employed.

For instance, a silicon rubber, etc. can be employed as a material of the elastic layer. In addition, the thickness of the elastic layer is in a range of, for instance, 150-250 μm.

The coating layer has a function as a toner-releasing layer for preventing the toner from attaching thereto. Accordingly, it is desirable that the coating layer is made of a fluororesin selected from a polytetrafluoroethylene (PTFE), a copolymer (PFA) of tetrafluoroethylene and perfluoroalkoxyethylene and a copolymer (FEP) of tetrafluoroethylene and hexafluoropropylene, and the thickness of the coating layer is in a range of, for instance, 20-50 μm.

The wax spreading blade 76 is made by molding an elastic material, such as a silicon rubber, a fluororubber, etc. The thickness of wax spreading blade 76 is set at, for instance, 3 mm. Further, wax spreading blade 76 is disposed at such a position that it press-contacts the surface of external heating roller 75 so that it extends in a direction same as the moving direction of endless fixing belt 71. Still further, its pressing force is set at a value in a range of, for instance, 100-500 mN/cm. It is also applicable that a fluororesin is coated on the surface of wax spreading blade 76.

The pressing roller 43 presses nip-forming roller 72 of rotatable fixing member 70 through endless fixing belt 71, disposed between them, with a pressing-force of, for instance, 2 N/cm, so as to form fixing nip portion N between endless fixing belt 71 and pressing roller 43. Further, the thickness of heat-resistant elastic layer 72b formed on nip-forming roller 72 of rotatable fixing member 70 is greater than that of heat-resistant elastic layer 43b formed on pressing roller 43. So such a shape that pressing roller 43, serving as a second rotatable fixing member, is convex relative to rotatable fixing member 70, serving as a first rotatable fixing member, is created at fixing nip portion N.

According to the duplex image-forming apparatus having the fixing apparatus described in the above, it becomes possible to attain the same performance and effects as those attained by the first embodiment.

According to the fixing apparatus embodied in the present invention, since the wax spreading blade is disposed at such a position that the wax spreading blade contacts any one of the first rotatable fixing member, the second rotatable fixing member and the external-contact rotating member, the melted wax oozed from toner fused at the fixing nip portion is uniformly leveled by the wax spreading blade contacting any one of the first rotatable fixing member, the second rotatable fixing member and the external-contact rotating member. Accordingly, even in such a case that most of the toner images formed on the transfer material reside at specific positions within a very limited area of the transfer material in its conveying direction and vertical direction, the wax can be uniformly spread all over the surface of the second rotatable fixing member as a final state. Accordingly, it becomes possible not only to improve the releasability of the toner all over the surface of the rotatable fixing member, but also to prevent the surface of the second rotatable fixing member from being hurt by the forced release member.

Further, since such a shape that the second rotatable fixing member is convex relative to the first rotatable fixing member, which contacts a surface of the transfer material, is created at fixing nip portion N, the transfer material P is conveyed out in a specific direction of approaching the second rotatable fixing member. Further, by disposing the forced release member at such a position that the forced release member contacts the second rotatable fixing member, the transfer material can be surely peeled off the second rotatable fixing member. In addition, since the toner for forming the toner image includes the wax, the wax serves as a lubricant between the second rotatable fixing member and the forced release member. Therefore, it becomes possible to prevent the surface of the second rotatable fixing member from being hurt by the forced release member.

According to the duplex image-forming apparatus embodied in the present invention, since the duplex image-forming apparatus is provided with the fixing apparatus detailed in the foregoing, it becomes possible to produce the high-quality fixed images over a long period.

Disclosed embodiments can be varied by a skilled person without departing from the spirit and scope of the invention.

1. A fixing apparatus for fixing toner including wax for release agent on a transfer material, comprising:
a first and a second rotatable fixing members, between which the transfer material is conveyed, to fix the toner on the transfer material with heat;
an external rotatable member provided in contact with at least one of the first and the second rotatable fixing members; and
a spreading blade for spreading the wax, provided in contact with at least one of the first rotatable fixing member, the second rotatable fixing member and the external rotatable member.

2. The fixing apparatus of claim 1,
wherein a nip portion shaped in a convex is created between the first rotatable fixing member and the second rotatable fixing member.

3. The fixing apparatus of claim 2,
wherein the first rotatable fixing member incorporates a heat source.

4. The fixing apparatus of claim 2,
wherein the second rotatable fixing member incorporates a heat source.

5. The fixing apparatus of claim 3,
wherein the external rotatable member is disposed at such a position that the external rotatable member contacts the first rotatable fixing member.

6. The fixing apparatus of claim 1,
wherein the external rotatable member incorporates a heat source.

7. The fixing apparatus of claim 1,
wherein the first rotatable fixing member includes a roller.

8. The fixing apparatus of claim 1,
wherein the first rotatable fixing member includes a belt.

9. The fixing apparatus of claim 1,
wherein the second rotatable fixing member includes a roller.

10. The fixing apparatus of claim 1,
wherein the second rotatable fixing member includes a belt.

11. The fixing apparatus of claim 1, further comprising:
a release member disposed at such a position that the release member contacts the surface of the second rotatable fixing member and having a plate for peeling the transfer material off the second rotatable fixing member.

12. The fixing apparatus of claim 11,
wherein a release layer is provided on at least an outer surface of a leading edge portion of the plate, which contacts the second rotatable fixing member.

13. The fixing apparatus of claim 12,
wherein the release layer is made of a fluororesin.

14. The fixing apparatus of claim 1,
wherein the external rotatable member is a rotating roller.

15. The fixing apparatus of claim 1,
wherein the external rotatable member is a circulating belt.

16. The fixing apparatus of claim 1,
wherein a width of the spreading blade is set at such a value that the width of the spreading blade is equal to or greater than that of a maximum width of the transfer material.

17. The fixing apparatus of claim 1,
wherein the first rotatable fixing member comprises a heat-resistant elastic layer made of a heat-resistant elastic material, a thickness of which is equal to or greater than 0.2 mm; and
wherein a toner releasing layer, made of a releasable resin including a fluororesin selected from a polytetrafluoroethylene (PTFE), a copolymer (PFA) of tetrafluoroethylene and perfluoroalkoxyethylene, and a copolymer (FEP) of tetrafluoroethylene and hexafluoropropylene, is formed on most-outer surfaces of both the first rotatable fixing member and the second rotatable fixing member.

18. The fixing apparatus of claim 1,
wherein a melting point of the wax is in a range of 60° C.-110° C.

19. An image-forming apparatus, comprising:
a developing device that stores toner including a wax having a releasing performance;
an intermediate transfer member on which a toner image developed by the developing device is transferred;
a transferring section to transfer the toner image from the intermediate transfer member to a transfer material;
a fixing section to fix the toner image onto the transfer material; and
a reversing section to convey the transfer material, passed through the fixing section, to the transferring section again,
wherein the fixing section includes:
a first rotatable fixing member and a second rotatable fixing member, both of which press-contact relative to each other to form a fixing nip portion so as to fix the toner image onto the transfer material with heat;
an external rotatable member disposed at such a position that the external rotatable member contacts any one of the first rotatable fixing member and the second rotatable fixing member; and
a wax spreading blade disposed at such a position that the wax spreading blade contacts a surface of at least one of the first rotatable fixing member, the second rotatable fixing member and the external rotatable member.
